(19) United States
(12) Patent Application Publication
(10) Pub. No.: US 2024/0262169 A1
(43) Pub. Date: Aug. 8, 2024

(54) AIR VENT FOR A MOTOR VEHICLE

(71) Applicant: ILLINOIS TOOL WORKS INC., Glenview, IL (US)

(72) Inventors: Harald NOICHL, Enkenbach-Alsenborn (DE); Gisella DEL CORE, Villanova D'Asti (IT)

(21) Appl. No.: 18/422,796

(22) Filed: Jan. 25, 2024

(30) Foreign Application Priority Data
Feb. 3, 2023 (DE) 10 2023 102 732.8

(51) Int. Cl. B60H 1/34

(52) U.S. Cl. CPC B60H 1/3421

(57) ABSTRACT

An air vent for a motor vehicle, wherein the air vent includes the following: a housing having an air inlet region and an opposite air outlet region; an airflow-conducting and/or airflow-restricting element arranged movably in the housing; a braking apparatus for braking the movement of the airflow-conducting and/or airflow-restricting element in relation to the housing, wherein the braking apparatus includes an elastic element arranged opposite the airflow-conducting and/or airflow-restricting element such that the airflow-conducting and/or airflow-restricting element is continuously in contact with the elastic element and, in any position, compresses an equally large subregion of the elastic element.

### TECHNICAL FIELD

The present invention relates to an air vent for a vehicle, in particular to an air vent having a braking apparatus for braking airflow-conducting elements.

### BACKGROUND

Air vents are typically used in vehicles in order to ventilate a vehicle interior. For this purpose, the air vent is arranged in the dashboard region of a vehicle and directs an airflow flowing through an air duct in the direction of the vehicle interior. An airflow-conducting and/or airflow-restricting element (also referred to as a blade in the following description, for the sake of simplicity) is arranged within the air duct in order to deflect or to restrict or completely discontinue the airflow. The airflow-conducting and/or airflow-restricting element is typically rotatable about a pivot axis, wherein the direction of the outflowing air can be adjusted by a rotation of the airflow-conducting and/or airflow-restricting element about its pivot axis.

In order to avoid an undesirable self-displacement of the airflow-conducting and/or airflow-restricting element, it is necessary to specify the minimum force required for the displacement of the airflow-conducting and/or airflow-restricting element.

The force setting can be carried out by means of spring elements, for example, such as coupling rods, which bias the airflow-conducting and/or airflow-restricting elements in the direction of their axis.

However, in such a design, there is a problem in that the coupling rods are often made of plastic. These plastic-made coupling rods relax over time, so that the friction forces used in order to adjust the force are reduced. As a result, the movement forces are also reduced over time.

In addition, for aesthetic reasons, some air vents only have a few, preferably only one, horizontally arranged blade. In this case, the operator generation, even by means of a metal coupling rod, is no longer sufficient due to the reduced number of preferably front-facing friction surfaces on the blade bearings. It is also disadvantageous here that no (sufficiently) high braking torques can be achieved due to the small friction diameters. As a countermeasure, it is also not possible to increase the friction through greater surface compression, because uncontrollable wear of the friction surfaces would be caused by this.

Another possibility to prevent self-adjustment of the blades is to create frictional forces in the blade bearing points.

However, it is disadvantageous in the described embodiment that, in such a construction, a plurality of bearing points are always used simultaneously in order to generate frictional or movement forces. Thus, a combination of frictional forces also takes place in the radial and axial direction, so that it is generally difficult to determine which bearing point actually contributes which amount of frictional force to the overall system.

Consequently, the force setting to a specified level is subjected to several iterative steps such that an accurate prediction for setting a particular force level is hardly possible. In addition, relaxation effects and signs of wear also occur here, which make it difficult to maintain a stable force level.

### SUMMARY

Proceeding from the prior art explained above, the problem addressed by the invention is to specify an air vent with a braking apparatus that eliminates the problems and disadvantages of the prior art mentioned above. In particular, it is a problem for the present invention to specify an air vent in which the braking effect is as constant as possible over the entire range of motion of the blades.

Accordingly, the present invention relates to an air vent for a motor vehicle, wherein the air vent comprises the following: a housing having an air inlet region and an opposite air outlet region; an airflow-conducting and/or airflow-restricting element arranged movably in the housing; a braking apparatus for braking the movement of the airflow-conducting and/or airflow-restricting element in relation to the housing, wherein the braking apparatus comprises an elastic element arranged opposite the airflow-conducting and/or airflow-restricting element (hereinafter “blade”) such that the blade is continuously in contact with the elastic element and, in any position, compresses an equally large subregion of the elastic element.

Compressing the elastic element results in a braking action that counteracts the movement of the blade. According to the invention, the elastic element and the blade are arranged in relation to one another such that a contact region between the elastic element and the blade is the same size while the blade is moved between its end positions. The consistent contact region ensures that the blade deforms the elastic element in each position in equal parts, i.e., it always deforms an evenly sized subregion. Consequently, the elastic element generates consistent resetting forces over the entire range of motion of the blade, whereby the adhesion and/or slide friction of the blade along the elastic element remains substantially constant.

According to a further embodiment, the elastic element is curved. The curvilinear configuration of the elastic element is in particular advantageous when the blade is pivotable in relation to the housing. In this case, when pivoting, the blade can run off the curve shape of the elastic element and thus generate an even braking effect. Also, due to the curvilinear shape of the elastic element, the stick-slip effect of the braking apparatus is improved. In an advantageous embodiment, the elastic element is in particular circularly arcuate.

According to a further embodiment, the elastic element is formed from silicone or elastomer, in particular TPE.

According to a further embodiment, the blade is pivotally connected to the housing by an axis of rotation, wherein a contact region of the blade with the elastic element upstream, i.e., in the direction of the air inlet region, is spaced from the axis of rotation, and wherein a radius of the curvilinearly formed elastic element corresponds to the distance between the axis of rotation and the contact region of the blade. According to this embodiment, it is ensured that the blade, in particular the side face of the blade, radially intersects the circularly arcuate elastic element at any position. This also effectively prevents the blade from remaining stuck against the elastic element, because the elastic element can be predictably deformed in the radial direction due to the radial contact, as will be explained in further detail below. Furthermore, an undesired jamming of the elastic element to the blade is prevented.

According to a further embodiment, the blade comprises a front face facing the air outlet region and a rear face facing the air inlet region, wherein first and second side faces are arranged between the front face and the rear face, and wherein one of the two side faces comprises a contact region which is continuously in contact with the elastic element. In other words, the elastic element is arranged laterally on the blade according to this embodiment. This allows for a particularly compact design and prevents the braking apparatus from undesirably influencing the direction of flow in the air vent.

According to a further embodiment, the contact region of the side face of the blade comprises a depression and/or a protrusion which is adapted to a shape of the elastic element. The depression or the protrusion can ensure that the elastic element does not catch with other parts of the blade despite deformation and thus causes a greater braking effect until the blade is clamped. For example, it can be achieved by a depression that the blade can be positioned particularly close to the braking apparatus in order to be able to cover the entire space of the air outlet region as far as possible.

According to a further embodiment, the blade comprises a biasing element connected to the braking apparatus such that the biasing element biases the side face of the blade against the elastic element. The biasing element ensures that the side face of the blade is in contact with the elastic element at all times. Also, due to the biasing element, it is achieved that the elastic element is deformed by the blade at all times with the same force.

According to a further embodiment, the biasing element is adjustable such that a biasing force generated by the biasing element is variable. Thus, the biasing force and the resulting friction between the elastic element and the blade can be adjusted particularly easily. This can be done at the factory, on the one hand. On the other hand, it is also conceivable for the user to adjust the biasing force individually to his or her needs.

According to a further embodiment, the braking apparatus comprises a side plate, which is laterally connected to the housing of the blade, wherein the side plate is configured so as to bear an axis of rotation of the blade. Accordingly, the braking apparatus serves on the one hand to rotatably mount the blade to the housing and on the other hand to brake the movement (for example the rotation) of the blade in relation to the bearing. Such a dual function ensures that the blade is already aligned with the elastic element of the braking apparatus directly after installation.

According to a further embodiment, the elastic element of the braking apparatus is arranged between the side plate and the housing. The elastic element is in particular clamped between the side plate and the housing. This is a particularly simple variant for connecting the elastic element to the housing of the air vent. The elastic element can in particular extend through an opening, which is formed between the side plate and the housing, as will be explained in further detail below.

According to a further embodiment, the elastic element is accommodated in an opening of the side plate. The elastic element can be inserted into the opening, for example even before the side plate is assembled. This can in particular also be done in a two-component injection molding process. The side plate with a built-in elastic element must merely be inserted into the housing of the air vent in order to provide the braking apparatus and, if necessary, also the bearing for the blade.

According to a further alternative, the elastic element is injected onto a side of the side plate facing the blade. In other words, according to this embodiment, it is not necessary for the elastic element to extend through an opening of the side plate and thus be secured. Rather, according to this variant, the elastic element is fixedly connected to a surface of the side plate, for example in a material-locking manner.

According to a further embodiment, the braking apparatus comprises at least one end stop, which is configured so as to restrict the movement of the airflow-conducting and/or airflow-restricting element. Thus, not only a constant braking effect can be achieved by the braking apparatus via the movement space of the airflow-conducting and/or airflow-restricting element. Rather, the movement space can be restricted simultaneously by the braking apparatus.

According to a further embodiment, the airflow-conducting and/or airflow-restricting element is movable, in particular pivotable, between a first end position and a second end position, and wherein the braking apparatus comprises two end stops and is configured such that [the] airflow-conducting and/or airflow-restricting element is in contact with the first end stop in the first end position and in contact with the second end stop in the second end position.

According to a further embodiment, the at least one end stop is elastic. An elastic end stop can prevent disruptive noises when assuming the end position. For example, the air vent can thereby be closed particularly quietly. The elasticity can also reduce wear on the end stops or the airflow-conducting and/or airflow-restricting element.

According to a further embodiment, the at least one end stop is formed integrally with the elastic element. Thus, the braking apparatus is simple and inexpensive to manufacture.

### BRIEF DESCRIPTION OF THE DRAWINGS

The present invention will be described in further detail below on the basis of the exemplary embodiments shown in the figures.

### The Following are Shown:

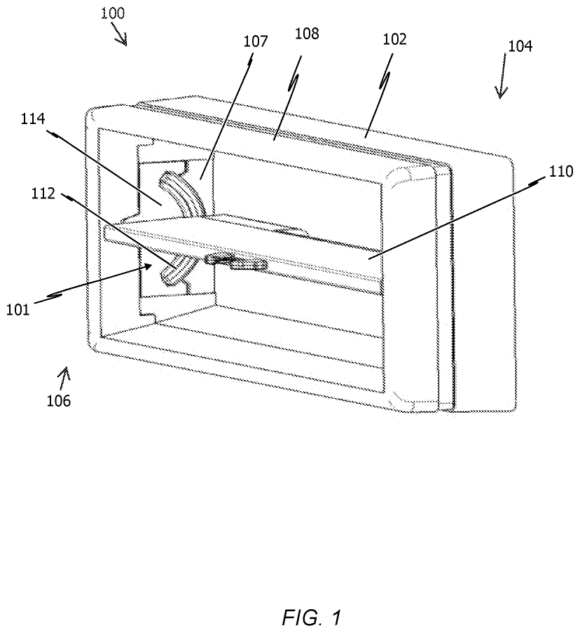

FIG. 1 a schematic, perspective view of an air vent according to a first embodiment of the present invention;

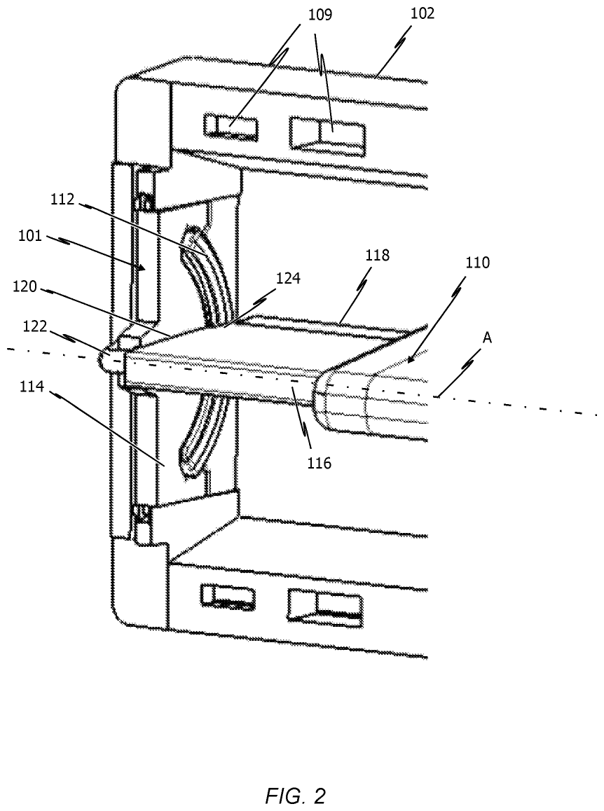

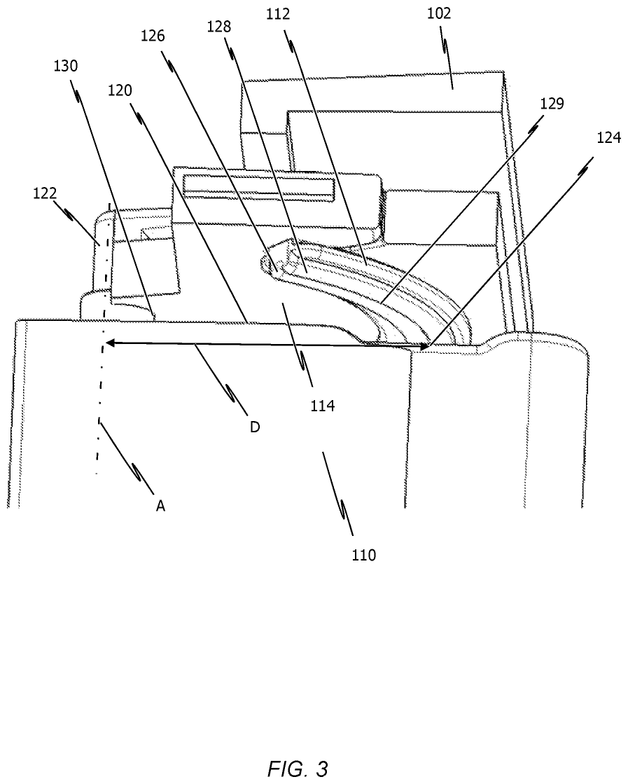

FIG. 2 an enlarged view of a subregion of the air vent according to FIG. 1;

FIG. 3 a cross-sectional view of the air vent according to FIG. 1;

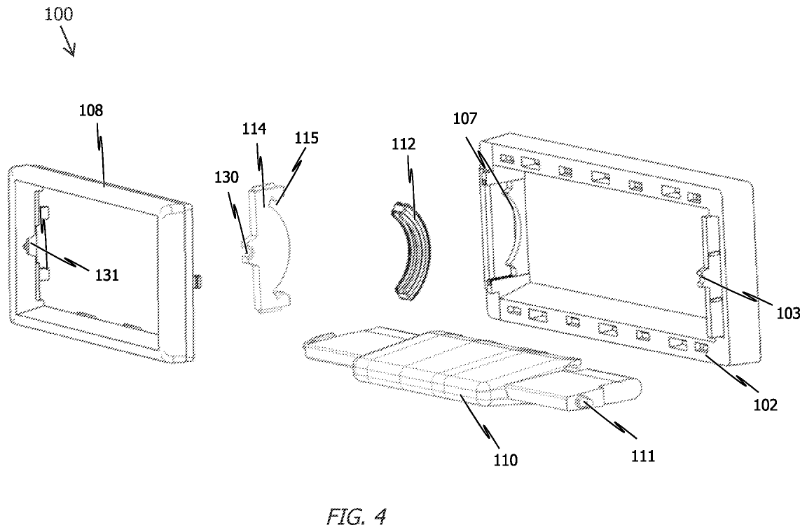

FIG. 4 an exploded view of the air vent according to FIG. 1;

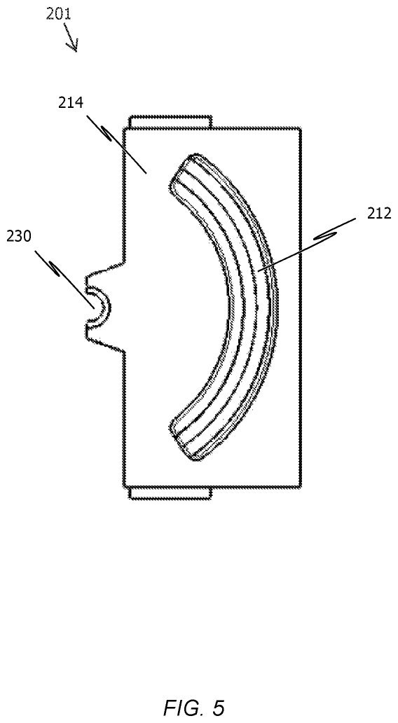

FIG. 5 a side view of an alternative braking apparatus;

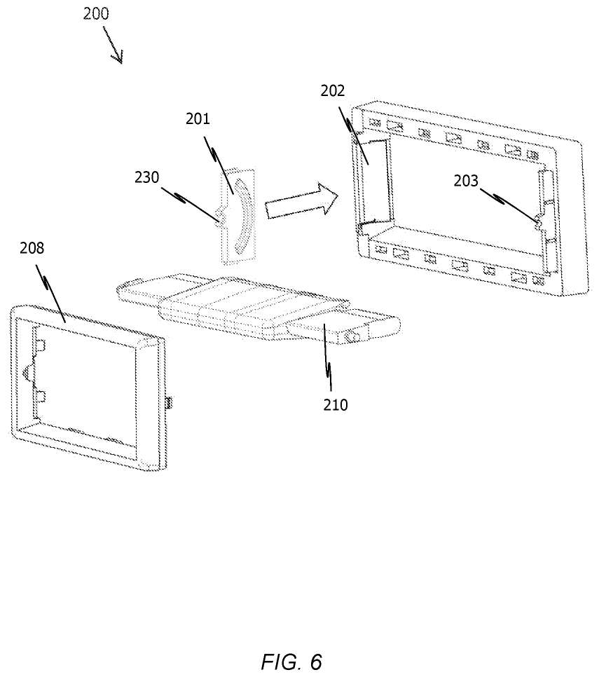

FIG. 6 an exploded view of an air vent according to a second embodiment of the present invention with a braking apparatus according to FIG. 5;

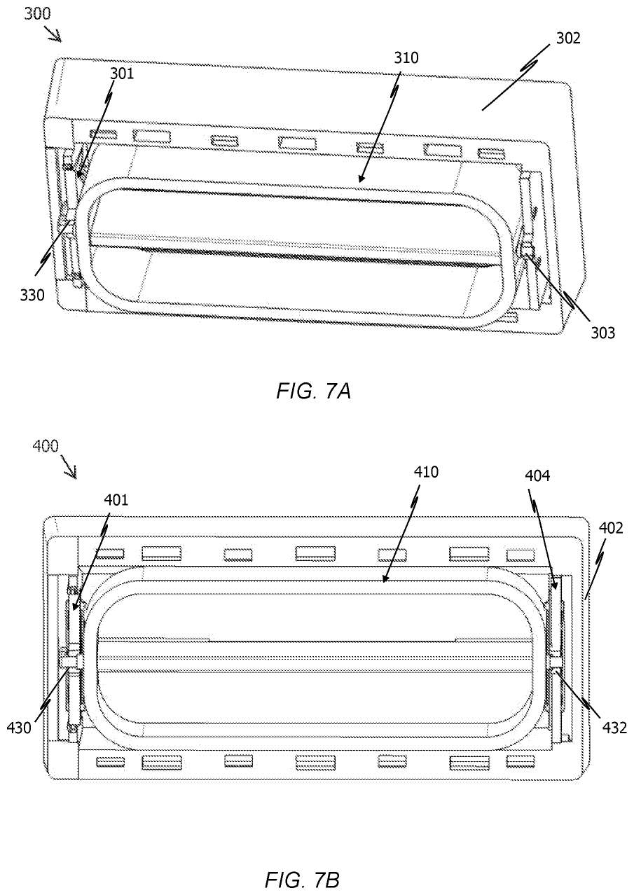

FIG. 7A a schematic view of an air vent according to a third embodiment of the present invention;

FIG. 7B a schematic view of an air vent according to a fourth embodiment of the present invention;

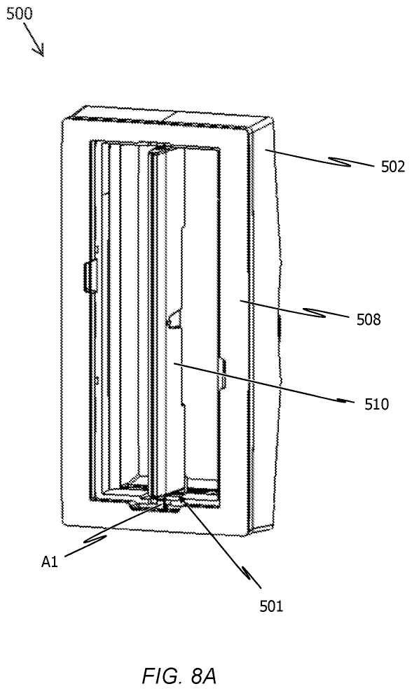

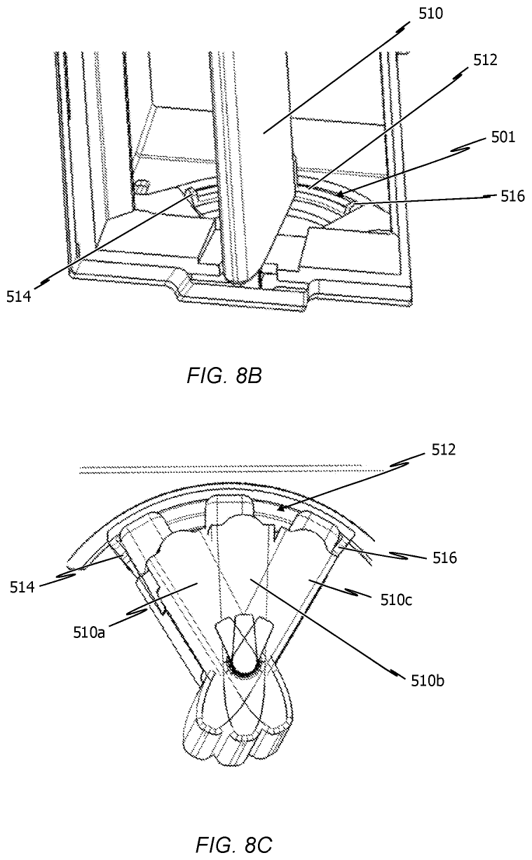

FIG. 8A a schematic view of an air vent according to a fifth embodiment of the present invention;

FIG. 8B an enlarged view of the air vent according to FIG. 8A; and

FIG. 8C a detailed view of the braking apparatus according to the embodiment according to FIG. 8A in various positions of the blade.

### DETAILED DESCRIPTION

FIGS. 1 to 4 show a first embodiment of the air vent according to the present invention. In FIG. 1, the air vent 100 is shown in a perspective view. The air vent 100 comprises a housing 102 having an air inlet region 104 and an air outlet region 106. An airflow-conducting and/or airflow-restricting element 110 is arranged between the air inlet region and the air outlet region 104, 106. In the embodiment shown here, the airflow-conducting and/or airflow-restricting element is a blade. Accordingly, for the sake of simplicity, reference is made hereinafter to the blade 110, wherein, of course, the invention is not limited thereto. Rather, other airflow-conducting and/or airflow-restricting elements can also be part of the air vent according to the invention and can be in communication with the braking apparatus.

The blade 110 is movably arranged within the housing 102. In particular, the blade 110 shown here can be pivoted about an axis of rotation (not shown here) in relation to a rotary bearing. When pivoting the blade 110 in relation to the axis of rotation A shown schematically in FIG. 2, the angle of the blade 110 is adjusted in relation to the housing 102. The outflow direction of the airflow from the air vent 100 is thereby adjusted in the manner known per se. In particular, the outflow direction is deflected downward when a rear portion of the blades is pivoted upward, and vice versa.

In some embodiments, a blade can also be used in order to adjust the air deflection in a horizontal direction, that is to say sideways.

A braking apparatus 101 is provided so as to prevent the blade 110, which is rotatably supported in the housing 102, from inadvertently collapsing downwards under the influence of gravity in the position shown in FIG. 1 and in order to ensure that a pivoting of the blade is only enabled when a specified amount of force is given. The braking apparatus 101 is also accommodated in the housing 102. The braking apparatus 101 is used in order to brake the movement of the blade 110 in relation to the housing 102.

The braking apparatus 101 comprises a side plate 114 arranged on at least one side of the blade 110 in the housing 102. The side plate 114 supports an elastic element 112, which is in contact with the blade 110 at all times and thus causes an adhesion friction or slide friction that counters the movement of the blade 110. To accurately position the elastic element 112 in relation to the blade 110, the housing 102 of the air vent 100 is in particular formed in two parts. A first part of the housing, which is arranged upstream, i.e., in the direction of the air inlet region 104, forms a return stop 107 for the elastic element. The side plate 114 forms a front stop for the elastic element 112. A snap-on frame 108 of the housing 102 serves to clamp the side plate and thus the elastic element 112 against the return stop 107 of the frame 102. However, this will be explained again in detail with a view of FIG. 4.

An enlarged view of the perspective view according to FIG. 1, in particular in the region of the braking apparatus 101, can be seen in FIG. 2. Unlike the view according to FIG. 1, the snap-on frame 108 is not shown in FIG. 2. Accordingly, FIG. 2 shows a plurality of openings 109 that cooperate with corresponding connectors (see FIG. 4) of the snap-on frame 108 in order to releasably attach the snap-on frame 108 to the front side of the frame 102.

As mentioned above, the blade 110 has a front side 116 facing the air outlet region 106 and a rear side 118 facing the air inlet region 104. A first side face 120 of the blade 110 is arranged between the front side 116 and the rear side 118. The blade 110 is in contact with the elastic element 112 of the braking apparatus 101 via a contact region 124 shown in further detail in FIG. 3. The remaining part of the side face 120 is preferably spaced apart from the braking apparatus 101 so that contact between the braking apparatus 101 and the blade 110 is given in particular only in the contact region 124.

To ensure an even contact between the side face 120 of the blade 110 and the elastic element 112, a biasing element 122 is provided. The biasing element is accommodated in a bearing 130 shown in FIG. 3, which is part of the side plate 114. The biasing element 122, as seen in FIG. 3, is hook-shaped in order to abut a rear side of the side plate 114 facing away from the side face 120. The hook-shaped biasing element 122 is biased against the rear side plate and thus generates a biasing force that biases the contact region 124 of the side face 120 of the blade 110 against the elastic element 112. For this purpose, the biasing element 122 can be connected to a spring arranged within the blade 110, which attempts to pull the biasing element 122 into the interior of the blade 110.

The blade 110 is pivotable about an axis of rotation A and thus within the bearing 130. A slide friction caused by the elastic element 112 and the contact region 124 opposes such a rotational movement of the blade 110. The slide friction produced is dependent on the one hand on the normal force, i.e., the biasing force of the biasing element 122, and on the other hand on a size of a contact surface between the contact region 124 and the elastic element 112. The braking apparatus 101 of the present invention is configured such that the contact region 124 as well as the pressing force are kept as constant as possible over the entire range of motion of the blade 110. As mentioned above, a constant pressing force is generated by the biasing element 122.

The constant contact region between the elastic element 112 and the blade 110 is in particular enabled by the curvilinear construction of the elastic element 112. For this purpose, the elastic element 112 has a bend radius, which substantially corresponds to the distance D of the contact region 124 of the blade 110 from the pivot axis A. Due to the fact that the bend radius of the elastic element 112 is equal to the distance D, the same contact region 124 of the side face 120 of the blade 110 remains in contact with the elastic element throughout the range of motion of the blade 110. Also, this will result in the contact region 124 of the blade 110 intersecting the elastic element 112 radially at each position.

From FIG. 3, it can further be seen that the elastic element 112 comprises two protrusions 126, 128. The two protrusions 126, 128 are in particular bead-shaped and extend from the elastic region 112 in the direction of the contact region 124. The two bead-shaped protrusions 126, 128 are arranged adjacent to one another and extend along the bend radius of the curvilinear elastic element. A centerline 129 extending between the two protrusions 126, 128 is aligned such that it is centrally arranged in the contact region 124 of the side face 120 of the blade 110. In particular, the deformation of the elastic element 112 by the contact region 124 results in a deformation of the two protrusions 126, 128. The first protrusion 126 can thereby evade radially inward, i.e., to the left in FIG. 3, while the second protrusion 128 can evade radially outward, i.e., to the right in FIG. 3. Thus, movement of the blade 110 in relation to the housing 102, and thus in relation to the elastic element 112 of the braking apparatus 101, will never cause the elastic element to tilt in relation to the contact region 124. Accordingly, the force required to move the blade 110 remains basically constant throughout the range of motion of the blade 110.

FIG. 3 further shows that the contact region 124 is provided in a depression of the side face 120 of the blade 110. However, it is also contemplated that the contact region can be arranged on a protrusion of the side face or is simply part of a straight side face.

FIG. 4 shows an exploded view of the air vent according to the first embodiment of the present invention. The construction of the air vent can be seen from the exploded view. The housing 102 comprises a protrusion that functions as a return stop 107 for the elastic element 112 of the braking apparatus 101. According to this embodiment, the elastic element is first mounted in the rear housing part 102 so that it is accommodated by the return stop 107. It can further be seen in FIG. 4 that the elastic element substantially corresponds to a curved I-profile.

After the elastic element 112 is attached to the return stop 107, the side plate 114 of the braking apparatus is inserted (in particular clipped) into the housing 102 such that the elastic element 112 is accommodated and secured in an opening 115 between the return stop 107 and the side plate 114.

A first bearing 130 for the axis of rotation 111 of the blade 110 is formed by the side plate 114. A second rotary bearing 103 is formed by the housing 102. Thus, the blade 110 can be placed in the two rotary bearings 130, 103 and fixed via the snap-on housing 108. For this purpose, the snap-on housing 108 comprises depressions 131, which respectively form the termination of the two bearings 130, 103.

A second embodiment of the inventive air vent is shown in particular in FIGS. 5 and 6. The second embodiment differs from the first embodiment in particular in that the braking apparatus 201 shown in FIG. 5 is configured as a prefabricated part. In other words, according to the second embodiment, the elastic element 212 is not clamped between the housing and the side plate, but rather held solely by the side plate 214. For this purpose, the elastic element 212 according to the second embodiment extends through a curvilinear opening of the side plate 214, not shown here. To this end, the side plate 214 can be manufactured in a first working step with a curvilinear opening, i.e., a curvilinear oblong hole, after which the elastic element 212 is pressed into the opening. Alternatively, the entire braking apparatus consisting of the side plate 214 and the elastic element 212 can be manufactured in a two-component injection molding process. Here, for example, the elastic element 212 is then injected into the opening of the side plate 214.

Also according to the second embodiment of the air vent 200, the braking apparatus 201 forms one of the two rotary bearings 203, 230.

In particular, the construction of the air vent according to the second embodiment can be seen in FIG. 6. Similar to the first embodiment, the housing 202 of the second embodiment also comprises a return stop, which serves to receive the braking apparatus. However, by contrast to the first embodiment, here it is the side plate 214 that comes into contact with the return stop of the housing 202. After insertion of the braking apparatus 201 into the housing 202, the blade 210 can be inserted into the rotary bearings 230, 203 and fixed with the snap-on frame 208.

A third embodiment of the air vent according to the present invention is illustrated in FIG. 7A. The air vent 300 according to FIG. 7A differs from the air vent 200 according to FIGS. 5 and 6 in particular in that, instead of the blade 110, a barrel-shaped airflow-conducting element is provided. According to this embodiment, the barrel-shaped element 310 is also accommodated in the housing 302 in two rotary bearings 330, 303. The first rotary bearing 330 is formed by a braking apparatus according to FIG. 5. The second rotary bearing 303 is formed by the housing 302. A corresponding snap-on frame (not shown) can secure the barrel-shaped element 310 in the housing. Also illustrated in FIG. 7A, a side face of the barrel-shaped element 310 is continuously in contact with the elastic element of the braking apparatus 301, such that a braking effect of the pivoting movement occurs due to the resulting slide friction.

FIG. 7B shows a further embodiment of the air vent according to the invention. The air vent 400 according to FIG. 7B comprises a housing 402 in which a barrel-shaped airflow-conducting element 410 is arranged. By contrast to the embodiment according to FIG. 7A, the air vent 400 comprises two braking apparatuses 401, 404. Both braking apparatuses 401, 404 are substantially identically formed and are mounted on opposite sides of the barrel-shaped element 410. The first braking apparatus 401 forms a first rotary bearing 430. The second braking apparatus 404 forms a second rotary bearing 432. The two opposing side faces of the barrel-shaped element 410 are in contact with corresponding elastic elements of the braking apparatuses 401, 404. However, according to FIG. 7B, only one biasing element is provided, namely on the first side of the first braking apparatus 401. This ensures the correct alignment of the barrel-shaped element 410 in relation to the elastic elements of the braking apparatuses 401, 404.

FIGS. 8A to 8C show a further embodiment of the air vent according to the invention. The air vent 500, shown perspectively in FIG. 8A, comprises a housing 502 having an air inlet region and an air outlet region. An airflow-conducting and/or airflow-restricting element is arranged between the air inlet region and the air outlet region. As in the embodiments illustrated above, the airflow-conducting and/or airflow-restricting element is a blade 510, wherein the invention is of course not limited thereto.

The blade 510 is movably arranged within the housing 502. In particular, the blade 510 shown here can be pivoted about an axis of rotation A1 in relation to a rotary bearing. When pivoting the blade 510 in relation to the axis of rotation A1, the angle of the blade 510 in relation to the housing 502 is adjusted.

In order to prevent the blade 510, which is rotatably supported in the housing 502, from rotating under the influence of gravity in the position illustrated in FIG. 8A and in order to ensure that a pivoting of the blade is only possible when a specified amount of force is applied, a braking apparatus 501 is provided. The braking apparatus 501 is also accommodated in the housing 502. The braking apparatus 501 serves to brake the movement of the blade 510 in relation to the housing 502.

The braking apparatus 101 comprises an elastic element 512, which is in contact with the blade 510 at all times and thus causes an adhesion or slide friction, which counteracts the movement of the blade 510. To accurately position the elastic element 512 in relation to the blade 510, the housing 102 of the air vent 500 is in particular configured in two parts. A first part of the housing, which is arranged upstream, i.e., in the direction of the air inlet region, forms a return stop for the elastic element. A snap-on frame 508 of the housing 502 serves to clamp a side plate and thus the elastic element 512 against the return stop of the housing 502. Reference is made once again to the explanations regarding FIG. 4.

An enlarged view of the perspective view according to FIG. 8A, in particular in the region of the braking apparatus 501, is illustrated in FIG. 8B. As in the preceding embodiments, the elastic element 512 of the braking apparatus 501 is also curved/bent.

The braking apparatus 501 comprises a first end stop 514 and a second end stop 516. The end stops 514, 516 are arranged at opposite ends of the elastic element 512. In the embodiment depicted here, the end stops 514, 516 are integrally formed with the elastic element 512. However, it is also contemplated that the end stops 514, 516 can be formed separately. The end stops 514, 516 extend substantially perpendicular to the elastic element 512.

As can be seen in particular from the detailed view according to FIG. 8C, the first end stop 514 serves as a stop for the blade 510 in a first end position. The first end position of the blade is illustrated in FIG. 8C with reference numeral 510a.

The opposing second end stop 516 serves as the stop for the blade 510 in a second end position. The second end position of the blade is illustrated in FIG. 8C with reference numeral 510c. Accordingly, the braking apparatus 501 can also be used in order to restrict the range of motion of the blade 510. The elastic configuration of the end stops 514, 516 means that the braking apparatus is especially quiet, in particular when reaching the end positions (e.g., when closing the air vent 500).

The exemplary intermediate position 510b shown in FIG. 8C corresponds to the position of the blade 510 as depicted in FIG. 8A. In this intermediate position 510b, the blade 510 is not in contact with either the first end stop 514 or the second end stop 516.

The present invention is not limited to the embodiments presented in the figures, but rather results from a combination of all of the features disclosed herein. In particular, it is also possible in the embodiments according to FIGS. 1-8C to position a braking apparatus on both sides of the blade.

1. An air vent for a motor vehicle, wherein the air vent (1) comprises:
a housing having an air inlet region and an opposite air outlet region;
an airflow-conducting and/or airflow-restricting element arranged movably in the housing;
a braking apparatus for braking movement of the airflow-conducting and/or airflow-restricting element in relation to the housing,
wherein the braking apparatus comprises an elastic element arranged opposite the airflow-conducting and/or airflow-restricting element such that the airflow-conducting and/or airflow-restricting element is continuously in contact with the elastic element and, in any position, compresses an equally large subregion of the elastic element.

2. The air vent according to claim 1,
wherein the elastic element is formed in a curvilinear fashion.

3. The air vent according to claim 2,
wherein the airflow-conducting and/or airflow-restricting element radially covers the elastic element in any position.

4. The air vent according to claim 2, wherein the airflow-conducting and/or airflow-restricting element is pivotally connected to the housing by an axis of rotation, and wherein a contact region of the airflow-conducting and/or airflow-restricting element with the elastic element upstream, i.e., in the direction of the air inlet region, is spaced apart from the axis of rotation, and wherein a radius of the curvilinear, elastic element corresponds to the distance between the axis of rotation and the contact region of the airflow-conducting and/or airflow-restricting element.

5. The air vent according to claim 1 4,
wherein the airflow-conducting and/or airflow-restricting element comprises a front face facing the air outlet region and a rear face facing the air inlet region, wherein first and second side faces are arranged between the front face and the rear face, and wherein one of the two side faces comprises a contact region which is continuously in contact with the elastic element.

6. The air vent according to claim 5,
wherein the contact region of the side face comprises a depression and/or a protrusion which is adapted to a shape of the elastic element.

7. The air vent (1) according to claim 5,
wherein the airflow-conducting and/or airflow-restricting element comprises a biasing element which is connected to the braking apparatus such that the biasing element biases the side face of the airflow-conducting and/or airflow-restricting element against the elastic element (112).

8. The air vent according to claim 7,
wherein the biasing element is adjustable such that a biasing force generated by the biasing element is variable.

9. The air vent according to claim 1,
wherein the braking apparatus comprises a side plate, which is laterally connected to the housing of the airflow-conducting and/or airflow-restricting element, and wherein the side plate is configured so as to bear an axis of rotation of the airflow-conducting and/or airflow-restricting element.

10. The air vent according to claim 9,
wherein the elastic element of the braking apparatus is arranged, between the side plate and the housing.

11. The air vent according to claim 9,
wherein the elastic element is accommodated in an opening of the side plate.

12. The air vent according to claim 9,
wherein the elastic element is injected on the side of the side plate facing the airflow-conducting and/or airflow-restricting element.

13. The air vent according to any claim 1,
wherein the braking apparatus comprises at least one end stop, which is configured so as to restrict the movement of the airflow-conducting and/or airflow-restricting element.

14. The air vent according to claim 13,
wherein the airflow-conducting and/or airflow-restricting element is movable, between a first end position and a second end position, and wherein the braking apparatus comprises two end stops and is configured such that the airflow-conducting and/or airflow-restricting element is in contact with the first end stop in the first end position and in contact with the second end stop in the second end position.

15. The air vent according to claim 13,
wherein the at least one end stop is elastic.

16. The air vent according to claim 13,
wherein the at least one end stop is formed integrally with the elastic element.
